(19) United States
(12) Patent Application Publication
(10) Pub. No.: US 2001/0054078 A1
(43) Pub. Date: Dec. 20, 2001

(54) Electronic database information integration process and a system and method for performing same

(76) Inventors: Jan Buckner, Chicago, IL (US); Gary Letourneau, Silver Spring, MD (US)

Correspondence Address: PATENTS+TMS, A Professional Corporation, 1914 North Milwaukee Avenue, Chicago, IL, 60647, US

(21) Appl. No.: 09/884,254

(22) Filed: Jun. 19, 2001

Related U.S. Application Data
(60) Provisional application No. 60/212,810, filed on Jun. 19, 2000.

(51) Int. Cl. G06F 15/16; G09G 5/00

(52) U.S. Cl. 709/206; 345/752

(57) ABSTRACT

A process, system, and method for gathering information through the use of electronic mail transmittals, and incorporating the information into an electronic database are provided. A user may send a textual template, via an electronic mail system, to a recipient who edits the information contained within the template. The recipient then returns the edited textual template to the user via electronic mail. The information contained within the edited textual template is then processed by the user's electronic database system and integrated into the user's electronic database.

This application claims the benefit of U.S. Provisional Application Ser. No.: 60/212,810, filed Jun. 19, 2000.

### BACKGROUND OF THE INVENTION

The present invention generally relates to a process, a system and a method for incorporating data into an electronic database. More specifically, the present invention relates to a process that provides the electronic gathering and incorporation of personal data into a computer database, personal digital assistant database, and the like. In addition, the present invention relates to a method for performing the same.

It is, of course, generally known to provide an electronic database for the storing of personal information. An example of the same is an electronic address book contained in the memory of a computer, personal digital assistant, personal information manager, and the like. Address books are maintained by electronic mail software and contain personal information regarding individuals, entities, and the like.

However, maintaining accurate information in an address book is a time-consuming, labor intense manual process which has increased in difficulty due to the rate of job changes, geographical moves, internet service provider selection changes, and multiple electronic mail addresses and telephone numbers. Furthermore, entering personal information into an electronic database is both tedious and time-consuming.

A need, therefore, exists for an improved process, system and method for obtaining and retrieving personal information from an individual or entity, and incorporating that information into an electronic address book or other electronic database.

### SUMMARY OF THE INVENTION

The present invention provides a process, a system and a method for electronically obtaining, retrieving and integrating personal data into an electronic database.

To this end, in an embodiment of the present invention, a method for integrating information electronically into an electronic database is provided. The method comprises creating a textual template wherein information from the textual template is recorded in the electronic database, configuring the textual template and sending the textual template via electronic mail to at least one recipient. The method further comprises the steps of editing the textual template, sending the edited textual template to the electronic database, and updating the electronic database with the edited textual template.

In an embodiment, the method for integrating information electronically into the electronic database is further comprised of the step of selecting at least one recipient of the textual template.

In an embodiment, the method for integrating information electronically into the electronic database is further comprised of the step of instructing the recipient to edit the textual.

In an embodiment, the method for integrating information electronically into the electronic database is further comprised of the step of customizing specific information provided by the recipient based on user specified requirements.

In an embodiment, the method for integrating information electronically into the electronic database is further comprised of the step of providing an electronic database wherein the electronic database is an address book.

In an embodiment, the method for integrating information electronically into the electronic database is further comprised of the step of configuring the textual template for content.

In an embodiment, the method for integrating information electronically into the electronic database is further comprised of the step of editing the textual template by providing missing information.

In an embodiment, the method for integrating information electronically into the electronic database is further comprised of the steps of providing a prompt to the user wherein a specific characteristic of the recipient is requested and electronically mailing the textual template to the recipient having the specific characteristic.

In an embodiment, the method for integrating information electronically into the electronic database is further comprised of the step of building the textual template with informational fields.

In another embodiment of the present invention, a method for updating a secondary electronic mail system with a primary electronic mail system is provided. The method is comprised of the steps of building a textual template, recording information from the textual template into the secondary electronic mail system, configuring the textual template and sending the textual template to a recipient electronic mail system. The method for updating a secondary electronic mail system with a primary electronic mail system is further comprised of the step of sending the textual template to the primary electronic mail system, editing the textual template by a recipient, sending the edited textual template from the recipient to the secondary electronic mail system and updating the secondary electronic mail system.

In an embodiment, the method for updating the secondary electronic mail system with the primary electronic mail system is further comprised of the step of configuring the textual template for content.

In an embodiment, the method for updating the secondary electronic mail system with the primary electronic mail system is further comprised of the step of configuring the textual template by instructing the recipient to edit the textual template.

In an embodiment, the method for updating the secondary electronic mail system with the primary electronic mail system is further comprised of the step of providing a primary electronic mail system wherein the primary electronic mail system is an address book.

In an embodiment, the method for updating the secondary electronic mail system with the primary electronic mail system is further comprised of the step of updating a secondary address book by using information from the edited textual template.

In an embodiment, the method for updating the secondary electronic mail system with the primary electronic mail system is further comprised of the step of editing the textual template by the recipient by transferring information electronically into the textual template.

In an embodiment, the method for updating the secondary electronic mail system with the primary electronic mail system is further comprised of the steps of providing a prompt to the user wherein a specific characteristic of the recipient is requested and electronically mailing the textual template to the recipient having the specific characteristic.

In an embodiment, the method for updating the secondary electronic mail system with the primary electronic mail system is further comprised of the step of building the textual template with informational fields.

In another embodiment of the present invention, a method for updating an address book contained in a secondary electronic mail system is provided. The method is comprised of the steps of building a textual template, recording information from the textual template into the address book of the secondary electronic mail system, configuring the textual template and electronically mailing the textual template to a recipient electronic mail system. The method is further comprised of the steps of editing the textual template by a recipient, sending the edited textual template from the recipient electronic mail system to the secondary electronic mail system, processing the edited textual template and updating the address book of the secondary electronic mail system with the edited textual template.

In an embodiment, the secondary electronic mail system defined in the method for updating the address book contained in the secondary electronic mail system, is a personal information manager.

In an embodiment, the secondary electronic mail system defined in the method for updating the address book contained in the secondary electronic mail system, is an instant messenger program.

In an embodiment, the method for updating the address book contained in the secondary electronic mail system is further comprised of the step of providing the secondary electronic mail system to a user.

In an embodiment, the method for updating the address book contained in the secondary electronic mail system is further comprised of the step of selecting recipients of the textual template.

In an embodiment, the method for updating the address book contained in the secondary electronic mail system is further comprised of the step of configuring the textual template for content.

In an embodiment, the method for updating the address book contained in the secondary electronic mail system is further comprised of the step of configuring the textual template by instructing a recipient to edit the textual template.

In an embodiment, the method for updating the address book contained in the secondary electronic mail system is further comprised of the step of editing the textual template by the recipient by transferring information electronically into the textual template sent by the user.

In an embodiment, the method for updating the address book contained in the secondary electronic mail system is further comprised of the steps of providing a prompt to the user wherein a specific characteristic of the recipient is requested and electronically mailing the template to the recipient having the specific characteristic.

In an embodiment, the method for updating the address book contained in the secondary electronic mail system is further comprised of the step of building the template with informational fields.

In another embodiment of the present invention, a system for updating electronic mail is provided. The system is comprised of a user and a recipient each having access to an electronic mail system, a textual template, recipient information for the textual template and an address book associated with the electronic mail system wherein the address book contains the recipient information.

In an embodiment, the system for updating electronic mail is further comprised of a screen display.

In an embodiment, the system for updating electronic mail is further comprised of a prompt on the screen display for assisting the user.

In an embodiment, the system for updating electronic mail is further comprised of means for electronically mailing the template to the recipient.

In an embodiment, the system for updating electronic mail is further comprised of a template with informational fields.

It is, therefore, an advantage of the present invention to provide a process, a system and a method for gathering information through electronic mail transmittals and integrating the information into an electronic database reducing the manual labor associated with information gathering.

Another advantage of the present invention is to provide a process, a system and a method for gathering information through electronic mail transmittals and integrating the information into an electronic database reducing the manual labor associated with data entry into an electronic database.

Yet another advantage of the present invention is to provide a process, a system and a method for gathering information through electronic mail transmittals and integrating the information into an electronic database to provide a current, comprehensive and accurate electronic database.

Another advantage of the present invention is to provide a process, a system and a method for gathering information through electronic mail transmittals and integrating the information into an electronic database to provide an accelerated information gathering process and information integration process.

Another advantage of the present invention is to provide a process, a system and a method for gathering information through electronic mail transmittals and integrating the information into an electronic database to provide the ability to personalize communications to recipients.

Additional features and advantages of the present invention are described in, and will be apparent from, the detailed description of the presently preferred embodiments and from the drawings.

### BRIEF DESCRIPTION OF THE DRAWINGS

FIG. 1 illustrates a flowchart of an embodiment of the present invention in a primary electronic mail application.

FIG. 2 illustrates a flowchart of an embodiment of the present invention in an initial update application.

FIG. 3 illustrates a flowchart of an embodiment of the present invention in a subsequent update application.

FIG. 4 illustrates a flowchart of an embodiment of the present invention in an internet-based personal information manager (PIM) application.

FIG. 5 illustrates a flowchart of an embodiment of the present invention in an instant messenger program application.

### DETAILED DESCRIPTION OF THE PRESENTLY PREFERRED EMBODIMENTS

The present invention generally provides a process, a system and a method for integrating information electronically into an electronic database, where the information has been gathered through electronic mail transmittals.

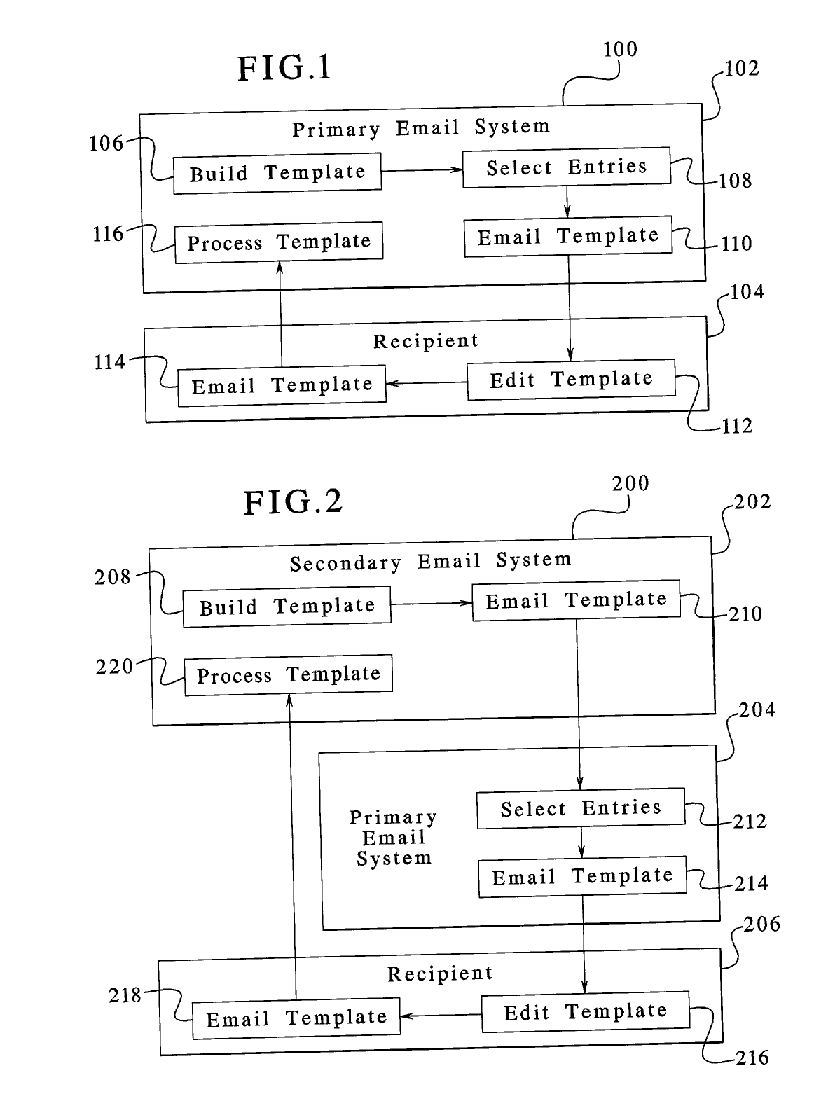

Referring now to the drawings wherein like numerals refer to like parts, FIG. 1 illustrates a flowchart for a process 100 in which the primary electronic mail (hereinafter referred to as “e-mail”) system 102, may be utilized to gather information from the recipient system 104. In a first step 106 of the process 100, a user may build a textual template for recording information within an address book of the primary e-mail system 102. The template may be configured for content and structure and may also have instructions for a recipient on how to edit the template, for example. In a second step 108 of the process 100, the user may select recipients of the template created in the first step 106 of the process 100. The recipients may be asked to provide specific information that may be customized based on user specified requirements. In a third step 110 of the process 100, the template may be sent via e-mail to the recipients chosen in the second step 108 of the process 100. After the recipient's e-mail system 104 receives the template, as shown at step 112, the recipient may edit the template by providing missing information or changing inaccurate information. The recipient may also edit the template by transferring information electronically and instantaneously into the template sent by the user. This editing may be performed by a recipient who has the system of the present invention installed on the recipient system 104. After editing is complete, as shown at step 114, the template may be e-mailed to the primary e-mail system 102 of the user. After the primary e-mail system 102 receives the edited template, as shown at step 116, the template may be processed and the address book of the primary e-mail system 102 may be updated using the information contained in the edited template.

FIG. 2 illustrates a flowchart for a process 200 in which a secondary e-mail system 202 may be updated through use of a primary e-mail system 204. The process 200 may begin within the secondary e-mail system 202. The user may build a textual template, as shown at step 208, for recording information within an address book of the secondary e-mail system 202. The template may be configured for content and structure and may also have instructions for a recipient on how to edit the template. The template may then be e-mailed, as shown at step 210, to the primary e-mail system 204. Within the primary e-mail system 204, recipients of the template may be chosen, as shown at step 212, whose information may be contained in an address book for the primary e-mail system 204. The template may then be e-mailed, as shown at step 214, to a chosen recipient's e-mail system 206. The recipient may then edit the template, as shown at step 216, by providing missing information or changing inaccurate information. The recipient may also edit the template by transferring information electronically and instantaneously into the template sent by the user. This editing may be performed by a recipient who has the system of the present invention installed on the recipient system 206. Next, the recipient may e-mail the edited template, as shown at step 218, to the user's secondary e-mail system 202. The template may then be processed, as shown at step 220, and the address book of the secondary e-mail system 202 may be updated using the information provided on the edited template.

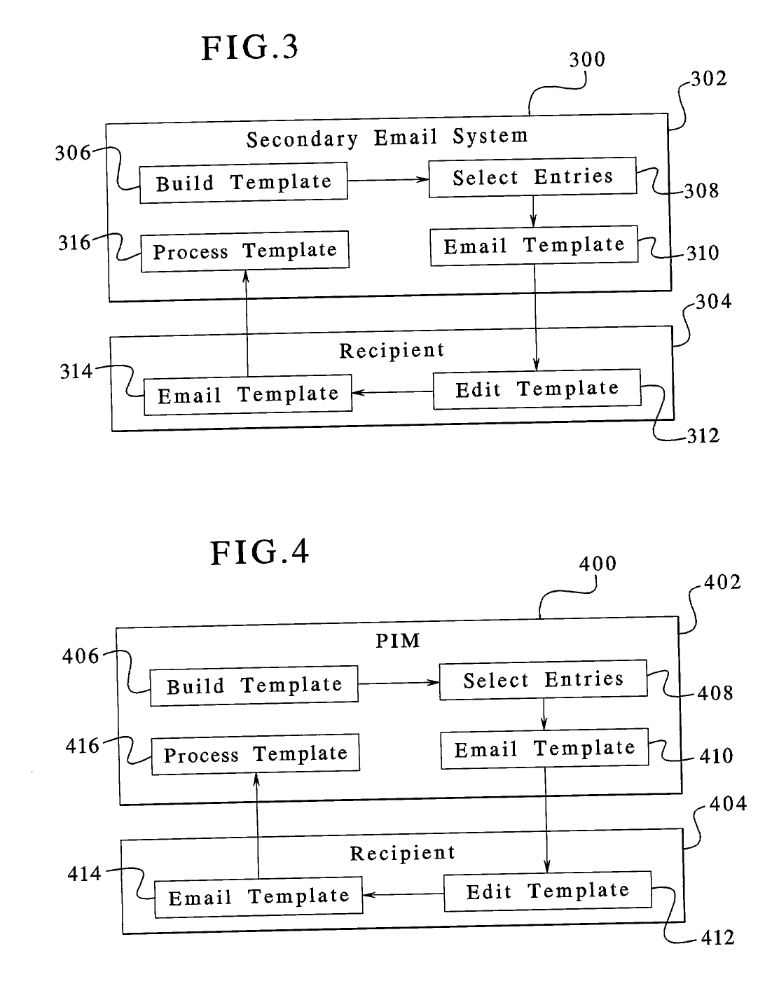

FIG. 3 illustrates a flowchart for a process 300 in which a user may update an address book contained in a secondary e-mail system 302. The user may build a textual template, as shown at step 306, for recording information within an address book of the secondary e-mail system 302. The template may be configured for content and structure and may also have instructions for a recipient on how to edit the template. Next, the user may select the recipients of the template, as shown at step 308. The template may then be e-mailed, as shown at step 310, to the e-mail system of the recipient 304. The recipient may then edit the template, as shown at step 312, by providing missing information or changing inaccurate information. The recipient may also edit the template by transferring information electronically and instantaneously into the template sent by the user. This editing may be performed by a recipient who has the system of the present invention installed on the recipient system 304. Then, the recipient may then e-mail the edited template, as shown at step 314, to the secondary e-mail system of the user 302. The edited template may then be processed, as shown at step 316, and the address book of the secondary e-mail system 302 may be updated using the information contained in the edited template.

FIG. 4 illustrates a flowchart for a process 400 in which a user may update an address book contained within a personal information manager (“PIM”) system 402. While within the PIM system 402, the user may build a textual template, as shown at step 406, for recording information within an address book of the PIM system 402. The template may be configured for content and structure and may also have instructions for a recipient on how to edit the template. The user may then select recipients of the template, as shown at step 408. Next, the user may e-mail the template, as shown at step 410, to a chosen recipient's e-mail system 404. The recipient may then edit the template, as shown at step 412, by providing missing information or changing inaccurate information. The recipient may also edit the template by transferring information electronically and instantaneously into the template sent by the user. This editing may be performed by a recipient who has the system of the present invention installed on the recipient system 404. The recipient may then e-mail the edited template, as shown at step 414, to the PIM system 402 of the user. Then, the edited template may be processed, as shown at step 416, and the address book of the PIM system 402 may be updated using the information contained in the edited template.

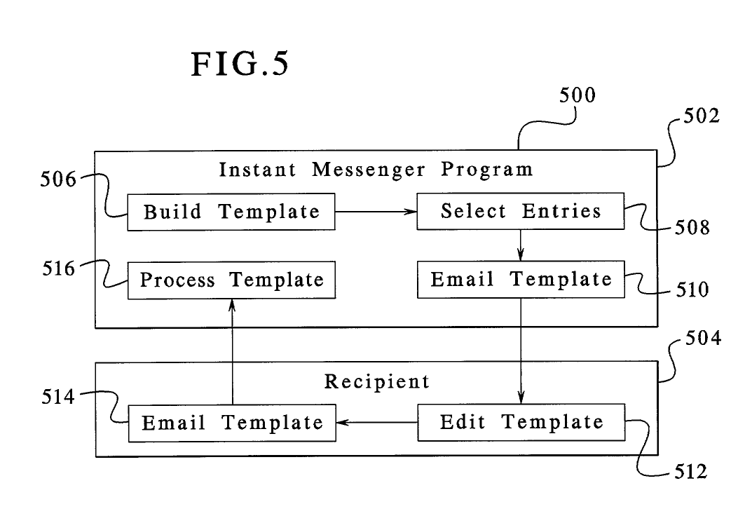

FIG. 5 illustrates a flowchart for a process 500 in which a user may update an address book contained within an instant messenger program (“IMP”) system 502. While within the IMP system 502, the user may build a textual template, as shown at step 506, for recording information within an address book of the IMP system 502. The template may be configured for content and structure and may also have instructions for a recipient on how to edit the template. The user may then select recipients of the template, as shown at step 508. Next, the user may e-mail the template, as shown at step 510, to a chosen recipient's e-mail system 504. The recipient may then edit the template, as shown at step 512, by providing missing information or changing inaccurate information. The recipient may also edit the template by transferring information electronically and instantaneously into the template sent by the user. This editing may be performed by a recipient who has the system of the present invention installed on the recipient system 504. The recipient may then e-mail the edited template, as shown at step 514, to the IMP system 502 of the user. Then, the edited template may be processed, as shown at step 516, and the address book of the IMP system 502 may be updated using the information contained in the edited template.

Appendix A illustrates screen displays for any of the processes 100, 200, 300, 400, and 500. The screen display may have a prompt where a user may choose to be assisted through a chosen process such as e-mailing a template only to those within a designated directory/category of the user's address book; e-mailing a template only to those whose last names begin with designated letters; and emailing a template only to those whose pre-existing records contain a designated search term. Various informational items including the date, confidentiality of the material on the screen, etc. may be provided. Background information may further be provided regarding functions of the present invention. As shown on page 1 of Appendix A, a template is illustrated that may be built by the user having standard informational fields and custom informational fields. Instructions to customize the fields of the template using a computer may also be provided. In addition, other instructions may be provided that allow the user to customize the fields of the template using, for example, a personal digital assistant or the like. A further prompt may be provided to the user with additional information regarding the fields of a template. As shown on page 2 of Appendix A, a table that provides suggested custom fields may be provided. Other suggestions for how to customize fields may also be provided. Additional instructions regarding sending templates to e-mail systems may further be provided.

As illustrated on page 3 of Appendix A, the user may then choose which function to perform, including checking the log of people, information, and the like that have been updated; e-mailing a template to everyone within the user's address book; e-mailing a template to only those who were last e-mailed a template; or, e-mailing a template to all individuals updated after a certain date which may be chosen by the user. Access to a first-time user screen may also be provided. A user may select recipients of a template. An instruction may be provided to the user to select or highlight the recipients of a template. A list of entries from the address book of the user's system may then be provided. Next, a notification, as well as instructions, may be provided regarding the assignment of entries to certain custom fields. The text may also indicate the manufacturer, brand or certain features of the device, thereby serving as a viral marketing/advertising vehicle for the manufacturer of the product.

A user may then choose to send a message to a recipient. The user may be asked whether a standard message is to be sent to all of the recipients of the template. If the user chooses to send a standard message to all recipients, a text box, as illustrated on page 4 of Appendix A, may be provided for entry of the message. The user may then be asked if an individual, personalized message is to be sent to a recipient. If the user chooses to send a personalized message, a text box, illustrated on page 5 of Appendix A, may be provided for entry of the message.

The user may confirm the recipient list. The recipient list may have a list of names, along with a field for marking those recipients who will receive personalized messages. The user may then be given an option of adding other names to the currently displayed list of recipients.

The user may then be notified, as illustrated on page 6 of Appendix A, about the status of a template when it is sent to a recipient. The user may then be able to pause the delivery of the e-mail or processing of the template and message within the e-mail system.

Next, the user may examine the e-mail message before sending the e-mail message to a recipient. Along with the template to be edited, an example of which is on page 7 of Appendix A, the e-mail message may have instructions for the recipient regarding how to edit the template and return the template to the user's e-mail system.

The user is then notified as to the status of the templates and messages that have been e-mailed. For a wireless device, a message may indicate that the templates and message have been sent. For a personal digital assistant and the like, a message may indicate that the template and message will be sent the next time a user synchronizes the device.

An example of an e-mail directory display that the recipient may see after receiving an e-mail from a user including a template and a message is illustrated on page 8 of Appendix A. The subject field of an e-mail directory display may contain the purpose of the user's e-mail, namely, obtaining information about the recipient.

An example of a template that the recipient may see upon opening of an e-mail is illustrated on page 9 of Appendix A. Along with the template, the e-mail message may have a greeting or a personalized message as well as a request by the user for the recipient to edit the template. The e-mail message may also have instructions for returning the template to the user and for providing the recipient with a copy for the recipient's records. In addition, the recipient may edit the template by transferring information electronically and instantaneously into the template sent by the user. This editing may be performed by a recipient who has the system of the present invention installed on the recipient system.

It should be understood that various changes and modifications to the presently preferred embodiments described herein will be apparent to those skilled in the art. Such changes and modifications may be made without departing from the spirit and scope of the present invention and without diminishing its attendant advantages.

We claim:

1. A method for integrating information electronically into an electronic database, the method comprising the steps of:
creating a textual template wherein information from the textual template is recorded in the electronic database;
configuring the textual template;
sending the textual template via electronic mail to at least one recipient;
editing the textual template;
sending the edited textual template to the electronic database; and
updating the electronic database with the edited textual template.

2. The method of claim 1 further comprising the step of:
selecting at least one recipient of the textual template.

3. The method of claim 1 further comprising the step of:
instructing the recipient to edit the textual template.

4. The method of claim 1 further comprising the step of:
customizing specific information provided by the recipient based on user specified requirements.

5. The method of claim 1 further comprising the step of:
providing an electronic database wherein the electronic database is an address book.

6. The method of claim 1 further comprising the step of:
configuring the textual template for content.

7. The method of claim 1 further comprising the step of:
editing the textual template by providing missing information.

8. The method of claim 1 further comprising the steps of:
providing a prompt to the user wherein a specific characteristic of the recipient is requested; and
electronically mailing the textual template to the recipient having the specific characteristic.

9. The method of claim 1 further comprising the step of:
building the textual template with informational fields.

10. A method for updating a secondary electronic mail system with a primary electronic mail system, the method comprising the steps of:
building a textual template;
recording information from the textual template into the secondary electronic mail system;
configuring the textual template;
sending the textual template to the primary electronic mail system;
sending the textual template to a recipient electronic mail system;
editing the textual template by a recipient;
sending the edited textual template from the recipient to the secondary electronic mail system; and
updating the secondary electronic mail system.

11. The method of claim 10 further comprising the step of:
configuring the textual template for content.

12. The method of claim 10 further comprising the step of:
configuring the textual template by instructing the recipient to edit the textual template.

13. The method of claim 10 further comprising the step of:
providing a primary electronic mail system wherein the primary electronic mail system is an address book.

14. The method of claim 10 further comprising the step of:
updating a secondary address book by using information from the edited textual template.

15. The method of claim 10 further comprising the step of:
editing the textual template by the recipient by transferring information electronically into the textual template.

16. The method of claim 10 further comprising the steps of:
providing a prompt to the user wherein a specific characteristic of the recipient is requested; and
electronically mailing the textual template to the recipient having the specific characteristic.

17. The method of claim 10 further comprising the step of:
building the textual template with informational fields.

18. A method for updating an address book contained in a secondary electronic mail system, the method comprising the steps of:
building a textual template;
recording information from the textual template into the address book of the secondary electronic mail system;
configuring the textual template;
electronically mailing the textual template to a recipient electronic mail system;
editing the textual template by a recipient;
sending the edited textual template from the recipient electronic mail system to the secondary electronic mail system;
processing the edited textual template; and
updating the address book of the secondary electronic mail system with the edited textual template.

19. The method of claim 18 wherein the secondary electronic mail system is a personal information manager.

20. The method of claim 18 wherein the secondary electronic mail system is an instant messenger program.

21. The method of claim 18 further comprising the step of:
providing the secondary electronic mail system to a user.

22. The method of claim 18 further comprising the step of:
selecting recipients of the textual template.

23. The method of claim 18 further comprising the step of:
configuring the textual template for content.

24. The method of claim 18 further comprising the step of:
configuring the textual template by instructing a recipient to edit the textual template.

25. The method of claim 18 further comprising the step of:
editing the textual template by the recipient by transferring information electronically into the textual template sent by the user.

26. The method of claim 18 further comprising the steps of:
providing a prompt to the user wherein a specific characteristic of the recipient is requested; and
electronically mailing the template to the recipient having the specific characteristic.

27. The method of claim 18 further comprising the step of:
building the template with informational fields.

28. A system for updating electronic mail, the system comprising:
a user and a recipient each having access to an electronic mail system;
a textual template;
recipient information for the textual template; and
an address book associated with the electronic mail system wherein the address book contains the recipient information.

29. The system of claim 28 further comprising:
a screen display.

30. The system of claim 29 further comprising:
a prompt on the screen display for assisting the user.

31. The system of claim 28 further comprising:
means for electronically mailing the template to the recipient.

32. The system of claim 28 further comprising:
a template with informational fields.
